(19) United States
(12) Patent Application Publication
(10) Pub. No.: US 2026/0359542 A1
(43) Pub. Date: Nov. 12, 2026

(54) THE CONFIGURATION OF FUNCTIONAL BLOCK SIZE IN INTEGRATED CIRCUIT DESIGN

(71) Applicant: INTERNATIONAL BUSINESS MACHINES CORPORATION, ARMONK, NY (US)

(72) Inventors: Alexander Laichinger, Ebersbach an der Fils (DE); Alexander Joel Suess, Hoepwell Junction, NY (US); Eduard Herkel, Stuttgart (DE); Timothy A. Schell, Cary, NC (US); William Edward Dougherty, JR., Pittsburgh, PA (US); Julian Stefanac, Bargfeld-Stegen (DE)

(21) Appl. No.: 19/265,502

(22) Filed: Jul. 10, 2025

(30) Foreign Application Priority Data
May 8, 2025 (GB) 2507023.6

(51) Int. Cl. G06F 30/392; G06F 111/04; G06F 111/20; G06F 117/12

(52) U.S. Cl. CPC G06F 30/392; G06F 2111/04; G06F 2111/20; G06F 2117/12

(57) ABSTRACT

Disclosed herein is a method of integrated circuit manufacturing using an Electronic Design Automation system. The Electronic Design Automation system comprises a configuration database storing functional block configuration data indexed using block specific hierarchical identifiers. The method comprises retrieving initial functional block configuration data for a chosen functional block from the configuration database using the block specific hierarchical identifier of the chosen functional block. The initial functional block configuration data is descriptive of a physical size of the chosen functional block. The method further comprises receiving size change data descriptive of an amended physical size for the chosen functional block. The method further comprises generating updated functional block configuration data using the size change data to modify the initial functional block configuration data. The method further comprises updating the configuration database using the updated functional block configuration data and the block specific hierarchical identifier of the chosen functional block.

### BACKGROUND

The present invention relates to the automated synthesis of physical designs for integrated circuits, in particular to the incorporation of functional blocks in the physical designs of integrated circuits.

The physical design of integrated circuits (ICs) is the process of transforming a circuit's logical representation into a physical layout that can be fabricated. When synthesizing a physical design of an integrated circuit, fully functional blocks may be incorporated into the design. Often times these functional blocks may be provided by other design groups and may also be licensed from third parties.

### SUMMARY

In one aspect a method of integrated circuit manufacturing using an Electronic Design Automation system to design an integrated circuit is disclosed. The Electronic Design Automation system comprises a configuration database storing functional block configuration data. The functional block configuration data is indexed using block specific hierarchical identifiers. The method comprises retrieving initial functional block configuration data for a chosen functional block from the configuration database using a block specific hierarchical identifier of the chosen functional block. The initial functional block configuration data is descriptive of a physical size of the chosen functional block. The method further comprises receiving size change data descriptive of an amended physical size for the chosen functional block. The method further comprises generating updated functional block configuration data using the size change data to modify the initial functional block configuration data. The method further comprises updating the configuration database using the updated functional block configuration data and the block specific hierarchical identifier of the chosen functional block.

In another aspect a computer program product is disclosed. The computer program product comprises a computer readable storage medium having computer-readable program code embodied therewith. The computer-readable program code is configured to implement an example of the method.

In another aspect a computer system is disclosed. The computer system comprises a processor configured for controlling the computer system. The computer system further comprises a memory storing computer-readable program code for implementing an Electronic Design Automation system. Execution of the computer-readable program code causes the processor to retrieve initial functional block configuration data for a chosen functional block from a configuration database using a block specific hierarchical identifier of the chosen functional block. The configuration database stores functional block configuration data indexed using block specific hierarchical identifiers. The initial functional block configuration data is descriptive of a physical size of the chosen functional block. Execution of the computer-readable program code further causes the processor to receive size change data descriptive of an amended physical size for the chosen functional block. Execution of the computer-readable program code further causes the processor to generate updated functional block configuration data using the size change data to modify the initial functional block configuration data. Execution of the computer-readable program code further causes the processor to update the configuration database using the updated functional block configuration data and the block specific hierarchical identifier of the chosen functional block.

### BRIEF DESCRIPTION OF THE DRAWINGS

In the following embodiments of the invention are explained in greater detail, by way of example only, making reference to the drawings in which:

FIG. 1 illustrates an example of a computing environment.

FIG. 2 depicts a cloud computing environment according to an example of the present invention.

FIG. 3 depicts an abstraction model layers according to an example of the present invention.

FIG. 4 shows a further view of the computing environment.

FIGS. 5A and 5B illustrate a method of using the computing environment of FIG. 4.

FIG. 6 illustrates an exemplary graphical user interface.

FIG. 7. Illustrates a size change in several functional blocks incorporated into hierarchical building block for an integrated circuit design.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one aspect there is a method of integrated circuit manufacturing using an Electronic Design Automation system to design an integrated circuit disclosed. An Electronic Design Automation system as used herein may encompass a software tool or a collection of software tools which receive a logic design of an integrated circuit and then automatically generate through a synthesis process a physical design of the integrated circuit. The design generated by the Electronic Design Automation system may contain details about the various layers and materials which make up this design of the integrated circuit. For example, one could take the design and then have masks made and have the integrated circuit manufactured at a semiconductor fabrication site or at a semiconductor foundry. The Electronic Design Automation system comprises a configuration database storing functional block configuration data. A functional block as used herein may encompass a complete sub-design or functional unit which may be integrated into an integrated circuit. Often times functional blocks are referred to as so-called “IP blocks.” The word “IP” is used as a label and nominally stands for intellectual property. Functional blocks are often referred to as IP blocks because the functional block may be provided by a different design group or even provided or licensed from a third party or a different company and could be the intellectual property of this third party. The term IP block is used even when there is no license involved, so the term “IP block” may be understood as a term of art synonymous with functional block. The functional block represents a functional component of an integrated circuit which may be dropped into place and used for this design. For example, the functional block may be a design for a memory (i.e., SRAM) cells. The functional block configuration data is data which is descriptive of the functional block. It may contain such things as the size of the functional block so that it is known how much space it takes up when it is integrated. It may also include such things as timing requirements or other details such as connections to the functional block so that it can be integrated with the rest of the integrated circuit. A configuration database as used herein may encompass a storage area or repository which stores and provides functional block configuration data. The Electronic Design Automation system may access the configuration database during the synthesis process and use this to provide a space and connections for the particular functional block.

The configuration database may be implemented in different ways in different examples. In one case, the configuration database may be a relational database. In other examples it could be a configuration file. In other examples it could be a folder storing data from various sources or links to various sources. If the configuration database is a folder, the folder could, for example, hold multiple files that contain the data that makes up the database. In some examples the data for one functional block could be contained within multiple files. In another example, there may be a file or directory which provides a pointer within a file system to find or obtain the functional block configuration data.

The functional block configuration data is indexed using block specific hierarchical identifiers. In some examples, the overall design of the integrated circuit is hierarchical. In this case the block specific hierarchical identifiers also represent the location of the functional block in the integrated circuit design's hierarchy. This block specific hierarchical identifier provides information about where to find the location of the functional block within a physical design of an integrated circuit. The method comprises receiving initial functional block configuration data for a chosen functional block from the configuration database using the block specific hierarchical identifier of the chosen functional block. The block specific hierarchical identifier of the chosen functional block is used to retrieve or locate the configuration data for this chosen functional block. The initial functional block configuration data is descriptive of a physical size of the chosen functional block. As was mentioned above, the initial functional block configuration data may contain various properties which describe the chosen functional block, but at the very least they contain a physical size of the chosen functional block. Having the physical size of the chosen functional block may enable it to be implemented into a physical design of an integrated circuit before all of the details are provided. For example, it enables a placeholder to be positioned where the chosen functional block may be later implemented. The method further comprises receiving size change data descriptive of an amended physical size for the chosen functional block. In this example, the physical size of the chosen functional block is amended or changed. This may represent a design change provided by the group providing or designing the chosen functional block. The method further comprises generating updated functional block configuration data using the size change data to modify the initial functional block configuration data. This may be equivalent to changing the values. The method further comprises updating the configuration database using the updated functional block configuration data and a block specific hierarchical identifier of the chosen functional block. For example, if it is stored in a relational database the block specific hierarchical identifier could be used as a key to locate or update the record in the relational database.

This example may be beneficial because it may provide for an improved means of automatically generating integrated circuits using an Electronic Design Automation system. It can often times be challenging or time-consuming to integrate functional blocks into an integrated circuit design. Sometimes the details of a functional block may not be available or may not be finalized when the design of the integrated circuit is started. The method may provide for a more straightforward and streamlined means of incorporating changes within a functional block design into the overall physical design of the integrated circuit. This, for example, may allow one to begin performing some of the design steps and then adapt the design more easily later to changes in the design of the functional block. In particular, this means that a size change of the functional block may be automatically completed within the hierarchy of the integrated circuit design based on the configuration data.

In another example the method further comprises receiving a preliminary logic design of the integrated circuit. The preliminary logic design as used herein may encompass a logic design of the integrated circuit. The term ‘preliminary’ in preliminary logic design is used to indicate one design of the integrated circuit and is considered a label. It enables the differentiation of different logic designs mentioned herein. The preliminary logic design comprises the chosen functional block. That is to say the logic design is designed using the chosen functional block. The method further comprises generating functional block configuration data for the chosen functional block. The functional block configuration data specifies an arbitrary physical size of the chosen functional block. By arbitrary physical size this means that an arbitrary or standard value for the chosen functional block may be chosen. The standard size of the chosen functional block (before generating the name (the block specific hierarchical identifier) and then applying the final size) is not necessarily saved in the configuration database (this may be the case when a new block is generated without having the name of the functional blocks at the beginning). If one wants to apply a standard/default size for all functional blocks, one may use a parameter (key value pair) to configure the Electronic Design Automation system to apply a certain size to the block. Key value pairs define values or parameters which are used to configure and control the behavior of the Electronic Design Automation System. For instance, a key can be “size” and the respective value would be the actual physical sizes of a block. In this example, the method steps described explain how to add the chosen functional block to the configuration database. When performing this, the size of the chosen functional block is not particularly relevant. The method further comprises receiving the block specific hierarchical identifier of the chosen functional block in response to running the Electronic Design Automation system using the preliminary logic design and the functional block configuration data as input. When the Electronic Design Automation system is run using these two inputs it then adds the chosen functional block and generates the block specific hierarchical identifier. Knowing the block specific hierarchical identifier may enable identification of data with respect to the chosen functional block within the design and also within the configuration database. The method further comprises entering the functional block configuration data for the chosen functional block into the configuration database using the block specific hierarchical identifier of the chosen functional block. When this entry is created the block specific hierarchical identifier may in some examples be used to store the arbitrary physical size. However, as the arbitrary physical size was created solely for the purpose of generating the block specific hierarchical identifier, the exact value that is stored in the configuration database is not particularly relevant. In some cases a null value could also be stored to indicate that the data has not been stored with the block specific hierarchical identifier yet. In the previously described method steps the updated functional block is then stored.

In another example the preliminary logic design of the integrated circuit can be any one of the following: a new logical design containing no functional blocks, a stored logical design containing functional blocks, and a stored logical design containing resized functional blocks. In this example a variety of functional blocks or lack thereof may be used when generating the preliminary logic design. A significant step may be to generate the functional block configuration data and then run the Electronic Design Automation system.

In another example the method further comprises deleting the functional block configuration data after receiving the block specific hierarchical identifier of the chosen functional block. Now that the block specific hierarchical identifier has been created there is no longer a need to have the functional block configuration data used to apply the standard size with the functional block was first created when running the Electronic Design Automation system on subsequent runs. Deleting the functional block configuration data may have for example the advantage of preventing duplicate block specific hierarchical identifiers for the chosen functional block being created in some examples. In any case, the block specific hierarchical identifier of the chosen functional block and its size may be retained in the configuration database.

In another example the method further comprises receiving an intermediate logic design of the integrated circuit. The functional design data has a size matching the amended physical size of the chosen functional block. The intermediate logic design as used herein may encompass a logic design of the integrated circuit and again, the term ‘intermediate’ may be understood as a label to differentiate the logic design from other versions of the logic design for the integrated circuit. In some examples the preliminary logic design and the intermediate logic design may be identical. The intermediate logic design comprises the chosen functional block. The method further comprises retrieving the updated functional block configuration data for the chosen functional block by the Electronic Design Automation system. This may be a function that the Electronic Design Automation system may automatically perform when the chosen functional block is incorporated into the intermediate logic design. The method further comprises generating an intermediate physical design of the integrated circuit by inputting the intermediate logic design and the updated functional block configuration data into the Electronic Design Automation system. Here, the Electronic Design Automation system is run again and in this case the updated functional block configuration data, which comprises the amended physical size, is used for generating the design. The method further comprises providing the intermediate physical design of the integrated circuit. The intermediate physical design comprises a physical placeholder for the chosen functional block. If the details of the chosen functional block are not known, the size data can be used to reserve a location and incorporate the functional block into the integrated circuit design, although the details or specifics of its construction are not yet known. The physical placeholder preferably has a size specified by the updated functional block configuration data.

It may be noted that the updating of the size of the chosen functional block with the amended physical size and also the generation of the intermediate logic design may be repeated multiple times. For example, during the design process the size may be changed a number of times and when this happens the system can be updated and then rerun.

In another example the method further comprises receiving functional design data for the chosen functional block. The functional design data has a size matching the amended physical size of the chosen functional block. The functional design data may be a design which is used to implement the chosen functional blocks. As the functional design data matches the size of the amended physical size of the chosen functional block it may be substituted by or inserted into the physical design of the integrated circuit. This example enables work to begin on the synthesis of a physical integrated circuit design before all of the design details like the functional design data of the functional blocks are known. Once a size of a chosen functional block is known or decided upon, the Electronic Design Automation system uses the amended physical size to essentially reserve the space in the physical design of the integrated circuit. Once the complete or changed design details of the chosen functional block are known it can be incorporated into synthesis runs to produce the physical integrated circuit design. However, since space was reserved for the chosen functional block, as specified by the amended physical size, the lack of a complete design for the chosen functional block did not bottleneck the design process.

In another example the method further comprises generating design constraints using their intermediate physical design. The generation of a physical design for an integrated circuit requires large amounts of computational time and expenditure. Often times the designers will tweak and modify the Electronic Design Automation system and repeatedly work on the design. By providing the design constraints certain aspects of the design which are wished to retain or beneficial to be retained can be set ahead of time and this may greatly accelerate the synthesis of subsequent physical designs using data such as constraints and insights which are gained from the intermediate physical design.

In another example the design constraints comprise any one of the following: physical placement data, the manufacturing node, timing rules, a cycle time, a semiconductor manufacturing technology node, transistor performance, transistor delay and/or switching time, transistor driving strength, transistor edge steepness, selection of a cell library for the semiconductor manufacturing technology node, power usage, placement assumptions for building blocks, block locations, and combinations thereof. Knowing these various design constraints in advance may be useful in accelerating the subsequent synthesis of the integrated circuit into a physical design.

In another example the method further comprises receiving a final logic design for the integrated circuit. The final logic design as used herein may encompass a logic design and the term ‘final’ in final logic design may be used as a label to differentiate various versions of the logic design. The method further comprises generating a production-ready physical integrated circuit design for the integrated circuit by inputting the final logic design, the functional design data, and the design constraints into the Electronic Design Automation system. Here, the production-ready physical integrated circuit design may be understood as a physical integrated circuit design which may be considered to be complete and which may be used for manufacturing the integrated circuit. For example, it may be used to generate masks and other data which may be used and sent to a foundry or semiconductor fabricator to manufacture the integrated circuit.

In another example the method further comprises manufacturing the integrated circuit using the production-ready physical integrated circuit design. For example, the production-ready physical design could be used to order masks and send an order with detailed instructions to a semiconductor foundry or fabrication site. This example may be beneficial because it may provide for more rapid and higher quality design of the production-ready physical integrated circuit design for the integrated circuit.

In another example the size change data is received from any one of the following: a configuration file, a configuration database, and a recommender system. In these examples, the size change data may be generated automatically. For example, as updated size change data becomes available it may be placed into a configuration file and when the Electronic Design Automation system is next run the size change data may be automatically updated in the configuration database. This may provide for a better and more effective management of the synthesis process of the integrated circuit. In one example, the recommender system is implemented using an artificial intelligence (AI) that is configured to generate suggested size parameters for one or more functional blocks within an integrated circuit design. The functional blocks may, for example, be analyzed based on a variety of input factors, including but not limited to prior layout data, performance constraints, power requirements, area budgets, and historical design outcomes. The recommender system may utilize machine learning models—such as supervised learning, reinforcement learning, or neural networks—to infer optimal sizing recommendations that meet design specifications while balancing competing constraints. These recommendations may be dynamically updated in response to changes in design inputs or constraints, thereby facilitating iterative optimization and reducing the manual effort typically required in block-level physical design planning.

In another example, the size change data is received from a graphical user interface. For example, the Electronic Design Automation system may provide a graphical user interface which enables an operator or user of the system to easily enter the size change data and manually adjust the behavior of the Electronic Design Automation system. This may, for example, provide greater flexibility in using the Electronic Design Automation system for a large number or complicated changes.

In another example, the configuration database stored data configured for generating physical placeholders for functional blocks used during different synthesis steps during operation of the Electronic Design Automation system to generate physical designs of the integrated circuits. The generation of physical placeholders for functional blocks may be beneficial because the design of particular functional blocks may not be available when the synthesis of the integrated circuit is started. The use of physical placeholders may enable the design of a functional block to be provided later.

In another example, the defining of the size of the functional blocks in the configuration database can be based on a preset of a parameter or entered by a user via a user interface directly when running the Electronic Design Automation system or upfront before running the Electronic Design Automation system. It may also be done by defining or other configuration parameters that can be used to calculate the size of the functional blocks in the configuration database. All of these methods may provide for a more flexible means of maintaining and updating the configuration database.

In another example, updating the initial functional configuration data comprises deleting parameters from a parameter set used for synthesizing the chosen functional block that is not needed by the Electronic Design Automation system. The deleting of the parameters from the parameter set may be useful in preventing the Electronic Design Automation system from generating identifiers which are no longer needed or have already been generated. A potential benefit is that deleting parameters from a parameter set used for synthesizing the chosen functional block that is not needed by the Electronic Design Automation system may prevent the Electronic Design Automation system from resetting the sizes of functional blocks in the configuration database.

In another example, the block specific hierarchical identifier enables the identification of functional blocks in the configuration database. When an integrated circuit is being designed there may be a large number of functional blocks which are used, and it may be difficult or impossible to identify the functional blocks in the configuration database without the block specific hierarchical identifier. Having the hierarchical identifier may enable accurate and quick location of the functional block not only in the configuration database but also in the logical design.

In another example, the block specific hierarchical identifier contains information about hierarchical levels of the functional blocks belonging to the integrated circuit. This may contain information about where the functional block is sitting in the hierarchical levels of the logic design. This may provide for easier identification of the functional blocks within the logical design.

In another example the functional block configuration data is JavaScript Object Notation (JSON) data. Defining the configuration data in this format may be beneficial because it has very good library support for common languages such as Python. The implementation of the JSON or JavaScript Object Notation data may therefore be more easily integrated into an Electronic Design Automation system. The functional block configuration data may also be Yet Another Markup Language (YAML). An advantage of using YAML is that it may be more readable by persons.

In another example the functional block configuration data is in Extensible Markup Language (XML) or in a Comma Separated Value (CSV) table. The use of either XML or CSV may be beneficial because it is a repurposing of common data formats which may also be easily implemented for the method.

In another example there is a computer program product comprising a computer-readable storage medium having computer-readable program code embodied therewith. The computer-readable program code is configured to implement an example of the method described above. The potential advantages of this computer program product have been discussed in the context of the method already.

In another aspect a computer system is disclosed. The computer system comprises a processor that is configured for controlling the computer system. The processor may represent multiple processors or computational systems located at one or more or various locations. Various aspects of the method may be performed locally using a computer or workstation or may be performed by computers distributed geographically. The computer program code may be configured for implementing the Electronic Design Automation system. The execution of the computer-readable program code causes the processor to retrieve initial functional block configuration data for the chosen functional block from a configuration database using a block specific hierarchical identifier of the chosen functional block. The configuration database stores functional block configuration data indexed using the block specific hierarchical identifiers. The initial functional block configuration data is descriptive of a physical size of the chosen functional block. The execution of the computer-readable program code by the processor causes it to receive size change data descriptive of an amended physical size for the chosen functional block. The execution of the computer-readable program code further causes the processor to generate updated functional block configuration data using the size change data to modify the initial functional block configuration data. Execution of the computer-readable program code causes the processor to update the configuration database using the updated functional block configuration data and the block specific hierarchical identifier of the chosen functional block. The potential advantages of this computer system have been previously discussed in the context of various methods.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for implementing an Electronic Design Automation system 400. In addition to Electronic Design Automation system 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Electronic Design Automation system 400, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

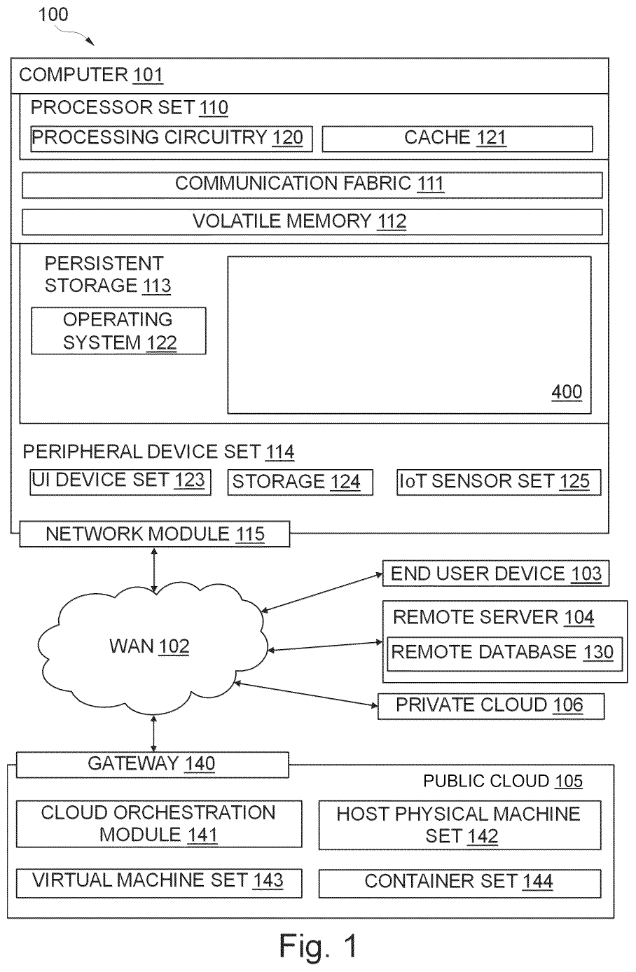

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored with Electronic Design Automation system 400 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included with Electronic Design Automation system 400 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

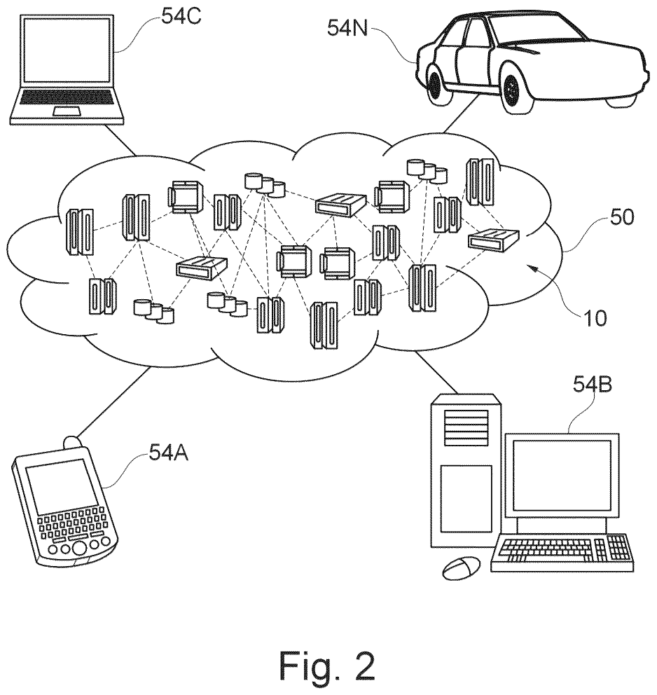

FIG. 2 It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service. Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

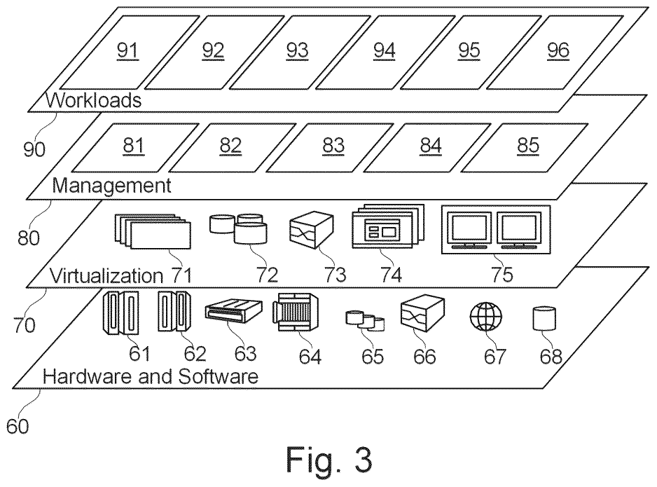

Referring now to FIG. 3, a set of functional abstraction layers provided by cloud computing environment 50 (FIG. 1) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. The database software 68 may be used to implement the source database and the target database as described above.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the implementation of a target database system 96 that uses an Electronic Design Automation system 400 as was described in the context of FIG. 1. In this example the target database system 96 may also provide data analytics processing.

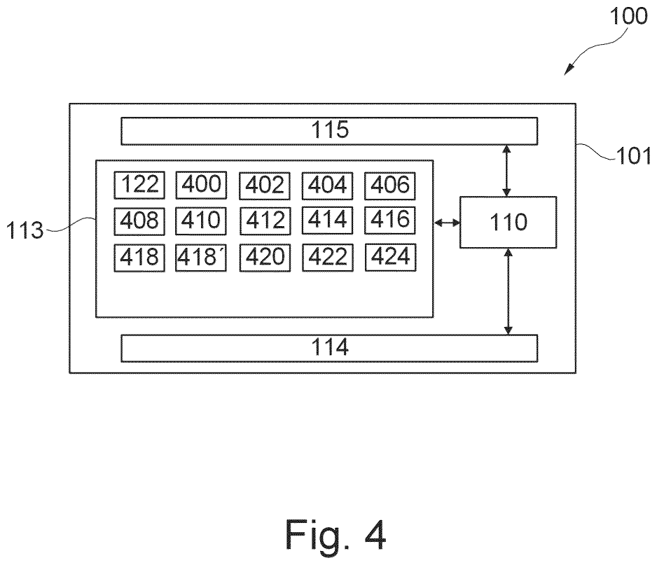

FIG. 4 shows a further view of the computing environment 100. Not all details of the computing environment 100 illustrated in FIG. 1 are repeated here. The persistent storage 113 is again shown as storing the operating system 122 and also the implementation of the Electronic Design Automation system 400. Additionally, the memory is shown as containing a preliminary logic design 402 which is one version of the logic design of the integrated circuit. The persistent storage 113 is further shown as storing the functional block configuration data 404. This is configuration data for the chosen functional block. The functional block configuration data 404 specifies at least an arbitrary physical size of the chosen functional block. The persistent storage 113 is further shown as storing a block specific hierarchical identifier 406 that was obtained by running the Electronic Design Automation system 400 using the preliminary logic design 402 and the functional block configuration data 404 as input.

The persistent storage 113 is further shown as containing a configuration database 408 which is used for storing configuration data descriptive of various functional blocks including the chosen functional block. The persistent storage 113 is shown as storing initial functional block configuration data 410 that was received for the chosen functional block by using the block specific hierarchical identifier 406 to identify the record for the chosen functional block in the configuration database 408. The persistent storage 113 is further shown as storing size change data 412. The size change data is descriptive of an amended physical size for the chosen functional block. The persistent storage 113 is further shown as containing updated functional block configuration data 414 that was generated using the size change data 412 to modify the initial functional block configuration data 410.

The persistent storage 113 is shown as further storing the intermediate logic design 416. The intermediate logic design 416 is another version of the logic design for the integrated circuit. The persistent storage 113 is further shown as containing an intermediate physical design 418 that was generated by inputting the intermediate logic design 416 and the updated functional block configuration data 414 into the Electronic Design Automation system 400. The intermediate physical design 418 may in some instances be considered to be design constraints or may be used to derive design constraints for further synthesis of the physical integrated circuit design. In other examples, design constraints 418′ can be derived or determined from the intermediate physical design 418. The persistent storage 113 is further shown as containing functional design data 420 for the chosen functional block. In the previous instances the Electronic Design Automation system may have been run with logic designs preliminary logic design 402 and/or intermediate logic design 416 that may not have included the actual design of the chosen functional block. The functional design data for the functional design data 420 is the actual design data which is needed to generate the physical design used for manufacturing the chosen functional blocks within the integrated circuit.

The persistent storage 113 is further shown as storing a final logic design 422. The final logic design 422 is a further version of the logic design for the integrated circuit. In some instances, this may be considered a complete design as it includes the chosen functional block and may be used to create physical designs in the integrated circuit which may be manufactured. The memory is further shown as storing a production-ready physical integrated circuit design 424 that was generated or synthesized by inputting the final logic design 422, the functional design data 420, and the design constraints 418′ into the Electronic Design Automation system 400. This production-ready physical integrated circuit design 424 may be used to directly generate an integrated circuit by performing such tasks as ordering masks and sending the data to a semiconductor fabrication site or a semiconductor foundry.

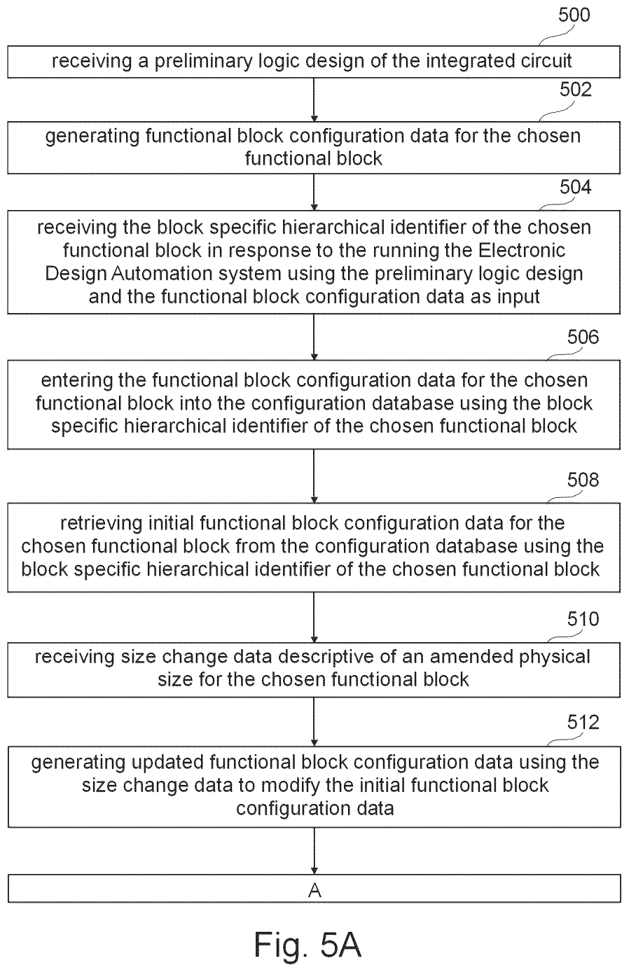

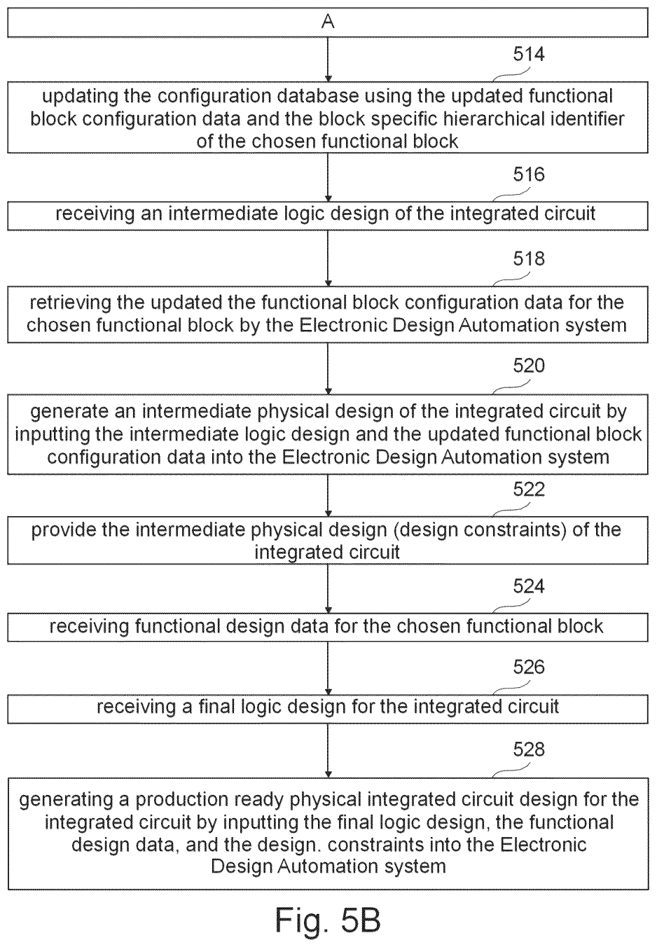

FIGS. 5A and 5B show a flowchart which illustrates a method of operating the computing environment 100 of FIG. 1. In step 500 the preliminary logic design 402 of the integrated circuit is received. The preliminary logic design 402 comprises the chosen functional blocks. In step 502 the functional block configuration data 404 is generated for the chosen functional block. In step 504 the block specific hierarchical identifier 406 is received in response to running the Electronic Design Automation system 400 using the preliminary logic design 402 and the functional block configuration data 404 as input. In step 506 the functional block configuration data 404 is entered for the chosen functional block into the configuration database using the block specific hierarchical identifier of the chosen functional block. In step 508 the initial functional block configuration data 410 is retrieved for the chosen functional block from the configuration database 408 using the block specific hierarchical identifier 406 of the chosen functional block.

In step 510 the size change data 412 is received for the chosen functional block. The size change data 412 is an amended physical size which is intended to be applied to the chosen functional block. In step 512 the updated functional block configuration data 414 is generated using the size change data 412 to modify the initial functional block configuration data 410. The method then proceeds on to step 514 in FIG. 5B. In step 514 the configuration database 408 is updated using the updated functional block configuration data 414 and the block specific hierarchical identifier 406 of the chosen functional block. In step 516 the intermediate logic design 416 is received for the integrated circuit. In step 518 the updated functional block configuration data 414 is retrieved for the chosen functional block by the Electronic Design Automation system 400.

In step 520 the intermediate physical design of the intermediate physical design 418 is generated by inputting the intermediate logic design and the updated functional block configuration data 414 into the Electronic Design Automation system 400. In step 522 the intermediate physical design 418 which may include design constraints 418′ derived from the intermediate physical design 418 are provided. These design constraints 418′ may aid in more rapid or higher quality synthesis of the integrated circuit design. In step 524 the functional design data 420 for the chosen functional block is received. In step 526 the final logic design 422 for the integrated circuit is received. In step 528 the production-ready physical integrated circuit design 424 is generated by using the final logic design 422, the functional design data 420, and the design constraints 418′ (or aspects of the physical design) as input into the Electronic Design Automation system 400.

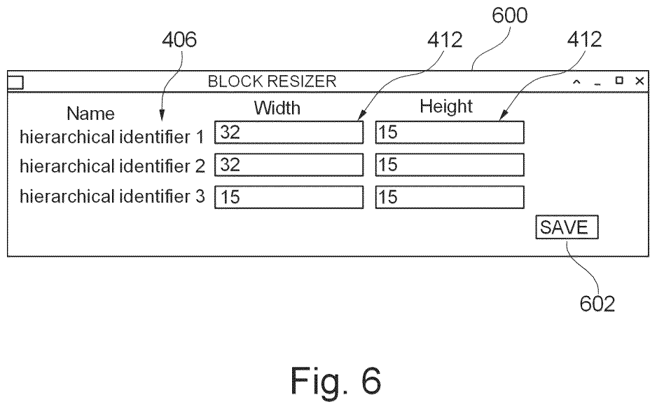

FIG. 6 illustrates an example of a user interface 600 that may be used to provide the size change data 412. The user interface 600 is shown as listing three different chosen functional blocks and lists their block specific hierarchical identifiers 406. Horizontal to this are width and height columns which are configured for receiving size change data 412 for each of the listed chosen functional blocks. The user, for example, can enter the width and height for at least one of the listed functional blocks. Once the size change data 412 has been entered it may be saved by clicking the save 602 button. Those changes are stored separately for each of the listed chosen functional blocks in the size change data 412 associated to each of the chosen functional blocks.

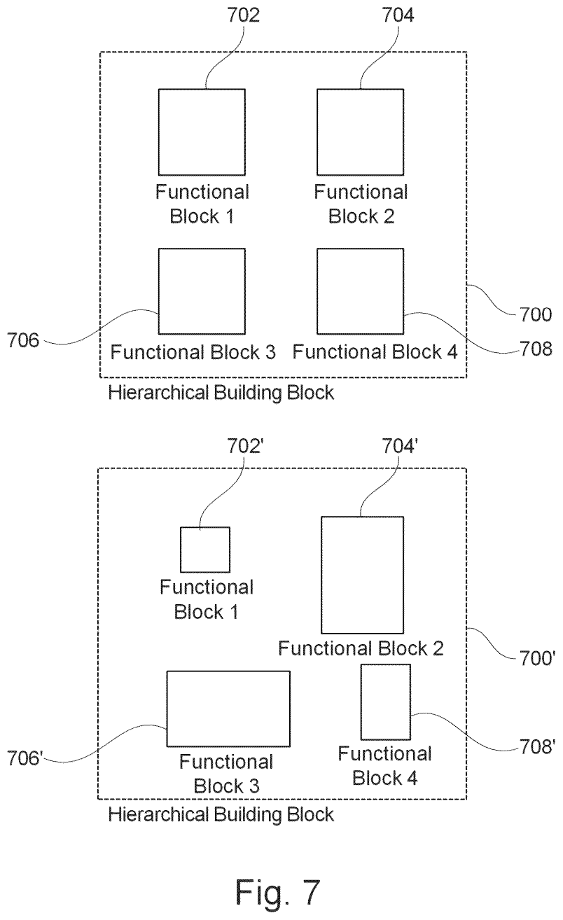

FIG. 7 illustrates two views of a hierarchical building block, denoted as 700 and 700′. A hierarchical building block is a functional building block that comprises one or more functional blocks. Hierarchical building blocks can also be nested which means that a hierarchical building block may possibly contain one or more other hierarchical building blocks. The hierarchical building block 700, 700′ contains for example one or several functional blocks or portions of a physical integrated circuit (IC) design that includes a plurality of functional blocks, namely 702, 704, 706, 708, 702′, 704′, 706′, and 708′. The size of the hierarchical building block 700, 700′ as well as the functional blocks 702, 704, 706, 708, 702′, 704′, 706′, 708′ is intended to abstractly represent their size within the physical integrated circuit design. In the first view of the hierarchical building block 700, the final size of the chosen functional blocks 702, 704, 706, 708 was unknown and set to an initialized or preliminary state, such as that corresponding to step 506 in FIG. 5A.

The physical dimensions of the functional blocks 702, 704, 706, 708 are shown as being identical and for example represent a default value being set in the functional block configuration data 404. Accordingly, default parameters or standard dimensions are assigned to functional block 1 702, functional block 2 704, functional block 3 706, and functional block 4 708. This default or standard parameter was entered into the functional block configuration data 404 which was used (in step 504) to generate block specific hierarchical identifiers 406 for the chosen functional blocks 702, 704, 706, 708 and was entered into in the configuration database 408 in step 506.

Once design details of the functional blocks 702, 704, 706, 708 are received (in step 510), their entries in the configuration database 408 may be updated (in step 514). When the physical integrated circuit design is synthesized again (for example in step 520 or 528) the result is the hierarchical building block 700′ which contains the resized functional blocks 702′, 704′, 706′, 708′. The dimensions and positions of the functional blocks may change, for example functional block 1 702′ has become smaller, and the dimensions of functional block 2 704′, functional block 3 706′, and functional block 4 708′ have changed. Also, the overall size of the area of placement for the chosen functional blocks could be reduced due to the size change of the chosen functional blocks.

What is claimed is:

1. A method of integrated circuit manufacturing using an Electronic Design Automation system to design an integrated circuit, wherein the Electronic Design Automation system comprises a configuration database storing functional block configuration data, wherein the functional block configuration data is indexed using block specific hierarchical identifiers, the method comprising:
retrieving initial functional block configuration data for a chosen functional block from the configuration database using the block specific hierarchical identifier of the chosen functional block, wherein the initial functional block configuration data is descriptive of a physical size of the chosen functional block;
receiving size change data descriptive of an amended physical size for the chosen functional block;
generating updated functional block configuration data using the size change data to modify the initial functional block configuration data; and
updating the configuration database using the updated functional block configuration data and the block specific hierarchical identifier of the chosen functional block.

2. The method of claim 1, wherein the method further comprises:
receiving a preliminary logic design of the integrated circuit, wherein the preliminary logic design comprises the chosen functional block;
generating functional block configuration data for the chosen functional block, wherein the functional block configuration data specifies an arbitrary physical size of the chosen functional block;
receiving the block specific hierarchical identifier of the chosen functional block in response to running the Electronic Design Automation system using the preliminary logic design and the functional block configuration data as input; and
entering the functional block configuration data for the chosen functional block into the configuration database using the block specific hierarchical identifier of the chosen functional block.

3. The method of claim 2, wherein the preliminary logic design of the integrated circuit is selected from a group consisting of: a new logical design containing no functional blocks, a stored logical design containing functional blocks, and a stored logical design containing resized functional blocks.

4. The method of claim 3, wherein the method further comprises deleting the functional block configuration data after receiving the block specific hierarchical identifier of the chosen functional block.

5. The method of claim 1, the method further comprising:
receiving an intermediate logic design of the integrated circuit, wherein the intermediate logic design comprises the chosen functional block;
retrieving the updated functional block configuration data for the chosen functional block by the Electronic Design Automation system;
generating an intermediate physical design of the integrated circuit by inputting the intermediate logic design and the updated functional block configuration data into the Electronic Design Automation system;
providing the intermediate physical design of the integrated circuit, wherein the intermediate physical design comprises a physical placeholder for the chosen functional block, wherein the physical placeholder has a size specified by the updated functional block configuration data.

6. The method of claim 5, wherein the method further comprises receiving functional design data for the chosen functional block, wherein the functional design data has a size matching the amended physical size of the chosen functional block.

7. The method of claim 6, wherein the method further comprises generating design constraints using the intermediate physical design.

8. The method of claim 7, wherein the design constraints are selected from a group consisting of: physical placement data, manufacturing node, timing rules, cycle time, a semiconductor manufacturing technology node, transistor performance, transistor delay and/or switching time, transistor driving strength, transistor edge steepness, selection of a cell library for the semiconductor manufacturing technology node, power usage, placement assumptions for building blocks, and blockage locations.

9. The method of claim 7, wherein the method further comprises:
receiving a final logic design for the integrated circuit; and
generating a production ready physical integrated circuit design for the integrated circuit by inputting the final logic design, the functional design data, and the design constraints into the Electronic Design Automation system.

10. The method of claim 9, wherein the method further comprises manufacturing the integrated circuit using the production ready physical integrated circuit design.

11. The method of claim 1, wherein the size change data is received from one selected from a group consisting of: a configuration file, the configuration database, and a recommender system.

12. The method of claim 1, wherein the size change data is received from a graphical user interface.

13. The method of claim 1, wherein the configuration database stores data configured for generating physical placeholders for functional blocks used during different synthesis steps during operation of the Electronic Design Automation system to generate physical designs of the integrated circuit.

14. The method of claim 1, wherein defining of the size of functional blocks in the configuration database can be based on a preset of a parameter or entered by user via a user interface directly when running the Electronic Design Automation system or upfront before running the Electronic Design Automation system, or by defining other configuration parameters that can be used to calculate the size of the functional blocks in the configuration database.

15. The method of claim 1, wherein updating the initial functional block configuration data comprises deleting parameters from a parameter set used for synthesizing the chosen functional block that is not needed by the Electronic Design Automation system.

16. The method of claim 1, wherein the block specific hierarchical identifier enables identification of functional blocks in the configuration database.

17. The method of claim 1, wherein the block specific hierarchical identifiers contain information about hierarchical levels of the functional blocks belonging to the integrated circuit.

18. The method of claim 1, wherein the functional block configuration data is selected from a group consisting of: JavaScript Object Notation data, YAML, XML, and a CSV table.

19. A computer program product comprising a computer-readable storage medium having computer-readable program code embodied therewith, said computer-readable program code configured to implement a method of integrated circuit manufacturing using an Electronic Design Automation system to design an integrated circuit, wherein the Electronic Design Automation system comprises a configuration database storing functional block configuration data, wherein the functional block configuration data is indexed using block specific hierarchical identifiers, the method comprising:
retrieving initial functional block configuration data for a chosen functional block from the configuration database using the block specific hierarchical identifier of the chosen functional block, wherein the initial functional block configuration data is descriptive of a physical size of the chosen functional block;
receiving size change data descriptive of an amended physical size for the chosen functional block;
generating updated functional block configuration data using the size change data to modify the initial functional block configuration data; and
updating the configuration database using the updated functional block configuration data and the block specific hierarchical identifier of the chosen functional block.

20. A computer system comprising:
a processor configured for controlling said computer system; and
a memory storing computer-readable program code and implementing an Electronic Design Automation system, execution of said computer-readable program code causes said processor to:
retrieve initial functional block configuration data for a chosen functional block from a configuration database using a block specific hierarchical identifier of the chosen functional block, wherein the configuration database stores functional block configuration data indexed using block specific hierarchical identifiers, wherein the initial functional block configuration data is descriptive of a physical size of the chosen functional block;
receive size change data descriptive of an amended physical size for the chosen functional block;
generate updated functional block configuration data using the size change data to modify the initial functional block configuration data; and
update the configuration database using the updated functional block configuration data and the block specific hierarchical identifier of the chosen functional block.
